(19) United States
(12) Patent Application Publication
(10) Pub. No.: US 2005/0214636 A1
(43) Pub. Date: Sep. 29, 2005

(54) Battery array with cooling system

(76) Inventor: Wenman Li, XinXiang (CN)

Correspondence Address: KAO H. LU, 686 LAWSON AVE, HAVERTOWN, PA, 19083, US

(21) Appl. No.: 10/809,306

(22) Filed: Mar. 24, 2004

(51) Int. Cl. H01M 10/50; H01M 2/12

(52) U.S. Cl. 429/120; 429/82; 429/62; 429/148; 429/159

(57) ABSTRACT

The present invention is related to the making of a battery array with cooling system, which includes outer case, at least two individual batteries connected in either serial or parallel and a cooling system. There are array of holes drilled on two opposing sides of the outer case to allow outside cooler air pass through. The present invention resolved over heating problem in large power battery assembly, realize multiple times of voltage output of lithium ion battery; in addition, when individual battery unit is broken it can be taken out of the assembly easily.

### FIELD OF THE INVENTION

The present invention relates to a method of packaging array of batteries and its associated cooling system.

### BACKGROUND OF THE INVENTION

Currently, to meet a higher voltage or larger current electricity requirement of a electronic device, a user can connect batteries serially or parallel together to get the desire result. Batteries, such as plumbous acid battery, cadmium nickel battery, hydrogen nickel battery, zinc air battery, lithium battery and fuel cell battery, all can be used in such fashion. However, as the capacity and volume of the battery increase, the more heat will be generated inside the battery during battery charging or discharging that increasing heat adversely affects battery's performance and longevity.

### SUMMARY OF THE INVENTION

There is a need to improve the way of packaging of an array of battery and adding a cooling system to prevent any overheat problem. The present invention includes an outer case, with arrays of ventilation holes on two opposing sides of the outer case. The inside of the case can contain at least two serial or parallel connected batteries and an imbedded cooling system between individual batteries. The cooling system has columns of multiple metal pipes or metal plate with hallowed holes, where the number of the pipes or holes in each column is determined by the height of the battery. The number of ventilation holes on outer case matches the number of the pipes or the holes in a metal plate. Furthermore, the positions of these holes are aligned to each other to allow outside air pass through them freely.

The range of diameter of the holes should be 1.5 mm to 5 mm. The hallowed holes in metal plates can be in either square or round. For a round hole its diameter should be from 1.5 mm to 5 mm; and for a square hole its size should be 1.5×1.5 mm to 5×5 mm.

The invention further comprises a fan, temperature sensors and temperature control circuit. The fan is installed inside the case and above individual batteries and is controlled by the temperature control circuit. Depending on the signals from the sensors, control circuit might be triggered to turn on the fan when temperature inside the battery array reaches preset level.

The individual battery can be lithium battery, plumbous acid battery, hydrogen nickel battery or cadmium nickel battery.

The present invention of battery array and associated cooling system solved over heating problem as capacity increases. It provides multiples times of voltage output of the individual batteries. And when an individual battery malfunctions, it can be taken out from the battery array easily.

### BRIEF DESCRIPTION OF THE DRAWING

FIG. 1 depicts an overall view of battery array with an imbedded cooling system;

FIG. 2 depicts a cutaway view of battery array;

FIG. 3 depicts a view from the top;

FIG. 4 depicts the configuration of large capacity battery array assembled by serial or parallel connected individual batteries.

FIG. 5 is a view of FIG. 4 from the top.

### DETAILED DESCRIPTION OF THE INVENTION

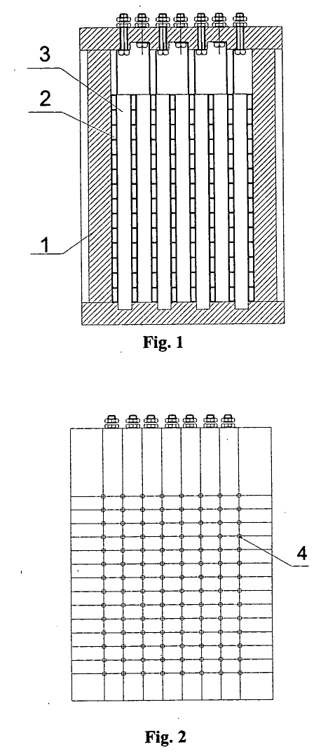

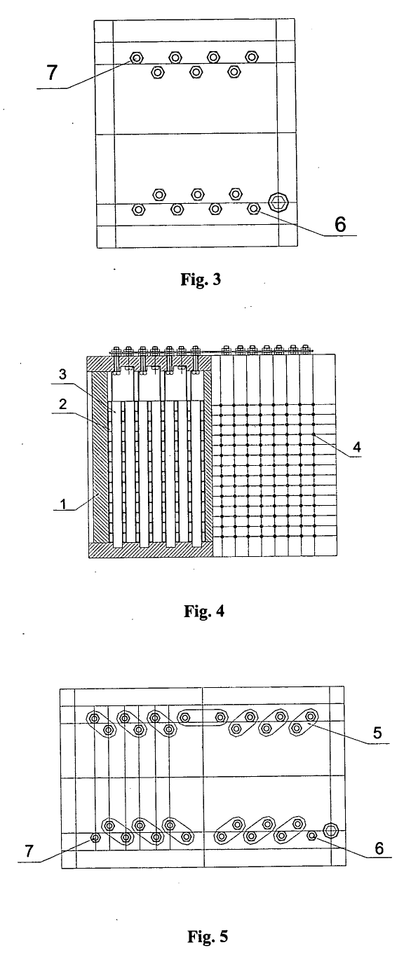

Referring FIG. 1 and FIG. 2, the present invention of battery array and associated cooling system includes battery outer case 1, arrays of ventilation holes 4 on two opposing sides (i.e. front and back) of the case 1. The case can contain at least two individual batteries 3 connected either in serial or in parallel. In FIG. 3, positive terminal and negative terminal of the battery array are indicated by number 6 and number 7 respectively.

The cooling system 2 of FIG. 1 consists of columns of multiple metal pipes or metal plate with a row of holes, and the number of holes in each column is determined by the height of the battery. That is taller the battery is, more holes/pipes are needed. The holes can be either in round shape or in square shape. The diameter of the holes should be large enough to allow air passes through unrestrictedly, but not too large to increase overall size of the battery. For round holes the proper diameter should be 1.5 mm-5 mm and for square ones the proper size should be 1.5×1.5 mm-5×5 mm. Ultimately, the actual size will be determined by the size of the battery. The number of ventilation holes on the case 1 matches the number of holes of the pipes. The locations of the holes 4 on the case and the holes of the pipes have to be aligned so that outside air can pass through the battery freely. When the battery is used on moving vehicle and placed at well-ventilated place, outside natural air will pass freely through holes 4 and inner pipes to bring heat out of the battery.

Referring FIG. 4 and FIG. 5, to speed up heat reduction, a fan 8 is installed on top of inside the case 1; temperature sensors 9 are installed between individual batteries and temperature control circuit to control the fan. When inner temperature reaches 65° C., the fan will be turned on the control circuit, fed on signal from the sensors to reduce the heat promptly.

The battery array can be used as a unit in even larger battery combination. That is multiple battery arrays can be combined in serial or parallel into large power battery group; when single unit is broken in the group it can be taken off from the group easily.

1. The battery array with cooling system comprising:
an outer case, where two opposing sides of the outer case have arrays of ventilation holes, at least two serial or parallel connected individual batteries enclosed in said outer case having imbedded cooling system between said batteries.

2. The battery array with cooling system of claim 1, wherein said imbedded cooling system further including at least one column having metal pipes or metal plate with a row of hallowed holes, where the number of said pipes or holes in each column is determined by the height of said battery, wherein the number of ventilation holes on said outer case matches the number of said pipes or the holes in said metal plates; and
the positions of the ventilation holes on the opposite side of said outer case are aligned to positions of the holes in said pipes or plates.

3. The battery array with cooling system of claim 1, wherein the diameter of the holes in said pipes is in a rang of 1.5 mm to 5 mm and the hallowed holes in said metal plate can be in either square or round; if they are in round the diameter will be from 1.5 mm to 5 mm; and if they are in square the size will be 1.5×1.5 mm to 5×5 mm.

4. The battery array with cooling system of claim 1, wherein the battery array further including at least one fan, at least one temperature sensor and a temperature control circuit, where the fan is installed inside of said outer case and above individual batteries, which the operations of the fan is controlled by the temperature control circuit and the sensor.

5. The battery array with cooling system of claim 1, wherein the individual battery can be lithium battery, plumbous acid battery, hydrogen nickel battery or cadmium nickel battery.
